(19) United States
(12) Patent Application Publication
(10) Pub. No.: US 2013/0030896 A1
(43) Pub. Date: Jan. 31, 2013

(54) METHOD AND SYSTEM FOR GENERATING AND DISTRIBUTING DIGITAL CONTENT

(71) Applicants: Shlomo Mai-Tal, Haifa (IL); Arie Ruttenberg, Ramat-Gan (IL); Yanir Shahak, Tel Aviv (IL)

(72) Inventors: Shlomo Mai-Tal, Haifa (IL); Arie Ruttenberg, Ramat-Gan (IL); Yanir Shahak, Tel Aviv (IL)

(21) Appl. No.: 13/191,171

(22) Filed: Jul. 26, 2011

(51) Int. Cl. G06F 17/00; G06Q 30/00

(52) U.S. Cl. 705/14.23; 715/202; 705/27.1

(57) ABSTRACT

A method for providing an enriched version of a creation, the method comprising: receiving a creation from an author, and storing the creation in a creation database; receiving through a computerized communication channel a suggested addition to the creation from one or more contributors and providing the suggested addition to the author; receiving approval for the suggested addition from the author, and storing the suggested addition in the creation database; displaying to a reader indications to the suggested addition; receiving a selection from a reader, the selection indicating a selected addition from the suggested additions; retrieving the creation and the selected addition from the creation database, and compiling an enriched version of the creation, the enriched version comprising the creation and the at selected addition, the enriched version adapted to be viewed on a reading digital platform; and providing the enriched version to the reader.

### FIELD OF THE INVENTION

The invention relates to digital content in general, and to creating and consuming digital books in particular.

### BACKGROUND OF THE INVENTION

The print technology that started with Johannes Gutenberg's invention enabled for the first time the mass production and distribution of written matter. This change, among all other effects, also separated the storytellers from their audiences, and moreover, compelled them to choose a single version of the story, the version brought to print. Some changes can be introduced only when new editions of a book are printed, but in general the invention of printing fixed each book into a single version.

Not only the text, but also other parts of the book, such as illustrations, artistic works, photographs, designs or others have to be determined prior to printing, and become part of the final version by the publisher, when preparing the book for print. In the regular printing process, it is impossible to alter a printed manuscript in any manner by anyone, including the author. Thus, the final version of a book is unchangeable in any aspect, including scope, content, amount of text, and various items such as style, illustrations, artworks, photographs, links or other parts.

E-books have been widespread for some time now. However, the final version of an e-book is also fixed once it becomes available for download. Providing different versions of a single e-book is equivalent to providing different books.

Therefore, readers wishing to view different or enriched versions of the original book or other content, or individuals wishing to provide such versions or enrichments or additions are left unanswered.

There is therefore a need in the art for a method and system for providing and distributing different versions of an original text of books or other content or media, wherein versions can differ in content, scope, text, illustrations or any other one or more parameters.

### SUMMARY OF THE INVENTION

One aspect of the disclosure relates to a method for providing an enriched version of a creation, the method comprising: in a server computing platform, receiving a creation from an author using an author client computing platform, and storing the creation in a creation database; receiving from one or more contributors using a contributor client computing platform, through a network, at least one suggested addition to the creation, and providing the suggested additions to the author; receiving approval for the suggested additions from the author, and storing the suggested additions in the creation database; displaying to a reader using a reader client computing platform indications to the suggested additions; receiving a selection from the reader, the selection indicating one or more selected additions from the suggested additions; retrieving the creation and the selected additions from the creation database, and compiling an enriched version of the creation, the enriched version comprising the creation and the selected additions, the enriched version adapted to be viewed on a digital reading platform; and providing the enriched version to the reader.

In some embodiments, the method further comprises receiving from the contributor a requested price for the suggested additions to the creation.

In some embodiments, the method further comprises determining compensation distribution between the author and the contributors; and distributing payment received from the reader between the author and the contributors in accordance with the compensation distribution determined and the selected additions.

In some embodiments of the method, the suggested additions comprise commercial information, and the reader may be entitled to a discount or is credited for at least part of the payment.

In some embodiments of the method, the digital reading platform is a digital book reader.

In some embodiments of the method, the creation is a book and the suggested addition is selected from the group consisting of: part of the creation; a translation;

a summary; comments; personal comments; an illustration; a drawing; a photograph; a design; an animation; a link; an audio file or stream; a video file or stream; broadcasting; an article; a map; a location coordinates; a critique; an alternative phrasing; musical notes; a recipe; a calculator; an address list; an electronic address list; and a phone directory.

In some embodiments of the method, compiling the enriched version of the creation comprises one or more actions selected from the group consisting of: associating the creation with an external addition; and integrating parts of inline additions into the creation.

In some embodiments of the method, compiling the enriched version of the creation comprises integrating symbols representing additions non-displayable by the reading digital platform into the creation.

In some embodiments of the method, the symbols are adapted to be scanned by an advanced display device, the advanced display device capable of displaying the additions non-displayable by the reading digital platform.

In some embodiments, the method further comprises receiving one or more types of additions to be suggested.

In some embodiments of the method, the suggested additions are internally represented as a matrix, wherein each dimension of the matrix relates to a type of addition, and wherein each dimension of the matrix comprises a number of entries equal to one plus a number of additions available of the type of addition.

In some embodiments, the method further comprises checking for the originality of the suggested additions.

Another aspect of the disclosure relates to a system for providing an enriched version of a creation, the system comprising: one or more servers comprising one or more processors and a storage device configured to access a creation database, the servers configured to execute: an author application comprising: a creation providing component for an author to provide a creation to be stored on the creation database; a reviewing and approving component for the author to view and approve at least one addition suggested by one or more contributors; a contributor application comprising an addition providing component for a contributor to suggest the additions to the creation; and a reader selection application comprising: a creation display and selection component for displaying a collection of the additions and receiving from a reader a selected addition; and a compiling and dispatching component for compiling an enriched version of the creation comprising the selected additions and dispatching the enriched version to the reader to be viewed on a digital reading platform.

In some embodiments, the system further comprises a client application selected from the group consisting of: an author client application; a contributor client application and a reader client application.

In some embodiments of the system, the digital reading platform is a digital book reader.

In some embodiments of the system, the digital reading platform is a personal computer, comprising a browser enhancement component for selecting a browser that matches the creation to view the creation, the browser enabling advanced reading features.

In some embodiments of the system, the advanced reading features are selected from the group consisting of: page turning, bookmarking, side notes editing and browsing to web pages through links.

In some embodiments of the system, the creation is a book and the suggested addition is selected from the group consisting of: part of the creation; a translation; a summary; comments; personal comments; an illustration; a drawing; a photograph; a design; an animation; a link; an audio file or stream; a video file or stream; broadcasting; an article; a map; a location coordinates; a critique; an alternative phrasing; musical notes; a recipe; a calculator; an address list; an electronic address list; and a phone directory.

In some embodiments, the system further comprises a financial component for determining compensation distribution between the author and the contributors, and for distributing payment received from the reader between the author and the contributors in accordance with the compensation distribution determined and the selected addition.

In some embodiments of the system, the compiling and dispatching component is configured to perform one or more actions selected from the group consisting of: associating the creation with an external addition; and integrating parts of inline additions into the creations.

In some embodiments of the system, the compiling and dispatching component is configured to integrate symbols representing additions non-displayable by the digital reading platform into the creation. In some embodiments of the system, the symbols are adapted to be scanned by an advanced display device, the advanced display device capable of displaying the additions non-displayable by the reading digital platform.

In some embodiments, the system further comprises an addition type management component for defining or approving types of additions to be suggested for the creation.

In some embodiments, the system further comprises a copyright checking component for checking for the originality of the at least one suggested addition.

Yet another aspect of the disclosure relates to a computer program product comprising: a non-transitory computer readable medium; a first program instruction for receiving a creation from an author, and for storing the creation in a creation database; a second program instruction for receiving, through a computerized communication channel, one or more suggested additions to the creation from one or more contributors and for providing the suggested additions to the author; a third program instruction for receiving approval for the suggested additions from the author, and for storing the suggested additions in the creation database; a fourth program instruction for displaying to a reader indications to the suggested additions; a fifth program instruction for receiving a selection from a reader, the selection indicating one or more selected additions from the suggested additions; a sixth program instruction for retrieving the creation and the selected additions from the creation database, and for compiling an enriched version of the creation, the enriched version comprising the creation and the selected additions, the enriched version adapted to be viewed on a reading digital platform; and a seventh program instruction for providing the enriched version to the reader, wherein said first, second, third, fourth, fifth, sixth and seventh program instructions are stored on said non-transitory computer readable medium.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a flowchart of steps in a method for creating an enhanced version of a creation, in accordance with some exemplary embodiments of the invention;

FIG. 2 is a flowchart of steps in a method for receiving an enhanced version of a creation, in accordance with some exemplary embodiments of the invention;

FIG. 3 is a flowchart of steps in a method for compiling a particular version of an enhanced version of a creation, in accordance with some exemplary embodiments of the invention; and

FIG. 4 is a system for creating, distributing and viewing an enhanced version of a creation, in accordance with some exemplary embodiments of the invention.

### DETAILED DESCRIPTION

The following description relates to providing and consuming different versions of books or other documents.

One technical problem handled by the disclosed subject matter relates to the provided and consumed scope, content or additions to a book, document or any other creation available in digital format. Usually, a book or any other document comes in one format, including a predetermined content, graphic design, additions such as illustrations or photographs, language, scope, notes such as footnotes or other personal notes, or the like.

However, some users, generally referred to as contributors, may wish to offer additions or enhancements to an existing book, such as but not limited to: abstracts or summaries of any length or depth; translations of the whole books or parts thereof to any language; different graphic designs such as traditional style, modern style or the like, colors or page sizes; different artistic additions such as illustrations, photographs, maps, graphs, or the like; additional data such as details related to various places, eras, topics, bibliography of an author, or any other details, links, audio or video clips, replacement parts such as different ending; personal comments, animations; links; audio files or streams; video files or streams; broadcasting; articles; location coordinates; critiques; alternative phrasings; musical notes; recipes; calculators; an address list; an electronic address list; a phone directory, or the like.

Some readers (there may be an overlap between the authors, contributors and readers) may be interested in receiving or purchasing any of the additions or enhancements, in order to receive a version of the book that is more adapted to their personal taste, preferences, or interests or otherwise enrich their experience. For example, a reader of the book may be interested also in obtaining a summary of the book for future reference, in one or more different sets of illustrations, in translations of the whole book or parts thereof, or the like.

Today's trend of transitioning from printed books to digital/electronic books, makes these desires of authors, contributors and readers alike, a much closer reality.

Another technical problem handled by the disclosed subject matter relates to contributors who are willing to provide such additional content or enhancement, such as translations, summaries, graphic designs, illustrations, or the like, in return for payment by readers interested in what they offer, wherein the payment may or may not be associated with the price of the original creation.

Yet another technical problem handled by the disclosed subject matter relates to accessing non-printable materials from a printed book or from a platform that does not support the display of such materials. For example, if a book has been enhanced with a video clip, a reader having a printed version of the enhanced book, or even a digital book reader cannot view the video clip.

Yet another technical problem handled by the disclosed subject matter relates to a system for reading digital books. A user may not want to purchase a dedicated reading device. However, when using a personal computer or another device that enables Web surfing, some books are best read using a specific browser type, while others are at their best using another browser type.

One technical solution is to provide an author and readers or other contributors (generally referred to as contributor or contributors) with a system and method in which the author places his creation, for example a book, an essay, a drawing, or any other creation, in an accessible location such as a web page, and the contributors may suggest additions, enhancements, derived works such as summaries or translations, or the like, generally referred to as additions.

The author can reject or accept the additions suggested by the contributors, and a price may be determined for each such addition, whether by the author or automatically, based for example on the originality of the addition, on its scope, or the like.

In some embodiments, the author himself can suggest multiple versions of the creation, for example a fairytale with a happy ending for young children and another ending for adults.

It will be appreciated that the process of suggesting additions and accepting or rejecting the additions may be repeated at any time, and that different or additional versions of the book can be suggested at different times.

It will also be appreciated that in some embodiments the process may be hierarchical, for example a translator may be suggested by sub-translators with enhancements or additions to his or her translation which they may accept or reject. In other embodiments, no further hierarchy is created and the original author is the one to accept or reject any such addition.

In some embodiments, commercial information or advertisements can also be suggested as additions, which may take any form, such as photographs, illustrations, text, audio, video or the like. If such commercial information is provided, the reader may enjoy a discount in the price he pays for the book, credits for further interactions, or coupons which may be associated with the book or advertisements. If the user enjoys a discount, the author or any of the contributors may receive a lesser sum from the reader, but they may also be compensated by the advertiser.

The book or creation is then offered to readers or other potential consumers, generally referred to as readers, with the additions. Each reader may select any one or more additions of any type, for example a summary of about 10% of the book, French and German translations and modern design.

The offer may be internally arranged as an N-dimensional matrix A, in which each dimension relates to a particular type of variation or addition, such as translation, graphic design, summary, or the like. For example, suppose that for a particular book there are 4 different sets of illustrations (i=0, 1 . . . 4) wherein 0 relates to no illustrations, six different sets of video clips (j=0, 1 . . . 6), and two different translations (n=0, 1, 2). This choice is therefore represented as an element in a 5×7×3 three-dimensional matrix, in which there is a total of 5×7×3=105 different entries, or versions of the book, for readers to choose from. For example, a reader may choose entry A[2][0][1] of the matrix , i.e., illustration set number 2, no video clip, and translation number 1.

In some embodiments, a reader may be interested in buying more than one addition of a particular type, for example two translations to two different languages, or even two translations to the same language. In such cases, the user may also choose an additional element of the matrix, for example A[0][0][2].

In some embodiments, a reader having purchased a book may purchase any one or more additions at any later time, wherein the reader can purchase additions that were not available when he first purchased the book.

The price the reader pays is determined upon the basic price of the creation and the prices of the various additions, and the sum is then split between the author and the contributors. If the reader received commercial information and is entitled to a discount, the author or any of the contributors may be paid less, but they may also be paid by the entity providing the commercial information.

Another aspect of the technical solution is the checking of each contribution for copyright infringement, so as to ensure an author that the creation is associated only with original matter, so that he bears no or lesser liability for copyright infringement. The checking may be performed automatically by applying copyright laws, for example by comparing texts and counting the number of consecutive identical words in the compared texts.

Yet another aspect of the technical solution is the adaptation of the enhanced creation to the reading equipment available to a user. If a user intends to read the creation on a computing platform that provides full functionality, such as a desktop computer, a laptop computer, a Smartphone, or the like all additions may be integrated. However, if for example a reader intends to use a printed version or an electric book reader which does not support video clips, a symbol such as a barcode may be printed or placed instead of the non-displayable content. The symbol may later be scanned by a device such as a Smartphone that supports the content type, and the relevant materials may be displayed.

Yet another aspect of the technical solution relates to a user using a personal computer or another device that enables Web surfing for reading an electronic book. The system may automatically choose the most appropriate browser for the specific book, optionally depending on its graphic design, contents such as illustrations or photos, or the like. The selected browser may provide a book reading module including relevant features such as page turning, bookmarking, side note editing, browsing to web pages through links, or the like.

One technical effect of the disclosed subject matter is providing a system and method for authors and optionally contributors to create multiple versions of a book or another creation, wherein the versions may differ in any parameter, such as content, scope, additions language, or the like.

This eliminates the availability of only a single version which is usually associated with books or even e-books, in which a book is only available in a single version as created by the author and possibly very few additional contributors the author has collaborated with, such as a single illustrator.

Using the method and system enables the creation of a large number of versions or enhancements for each book from which a reader can choose in accordance with his taste, interests, needs, financial resources or the like.

Another technical effect of the disclosed subject matter is the provisioning of a reward system in which each contributor is compensated in accordance with the originality, scope and possibly other parameters of his work.

Yet another technical effect of the disclosed subject matter is the provisioning of a consistent manner for checking of copyright infringement, so as to avoid associating a creation with infringing materials.

Yet another technical effect of the disclosed subject matter is the enablement of readers reading a printed version of the book or using an electric book reader to view non-displayable content such as video or audio clips.

Yet another technical effect of the disclosed subject matter is the enablement of readers reading a book using a general purpose computer such as a personal computer, to read the book using a browser which displays the specific book at its best. The reader can enjoy reading the book at high quality, optionally using reading-related features such as page turning, bookmarking, side notes editing, browsing to web pages through links, or the like.

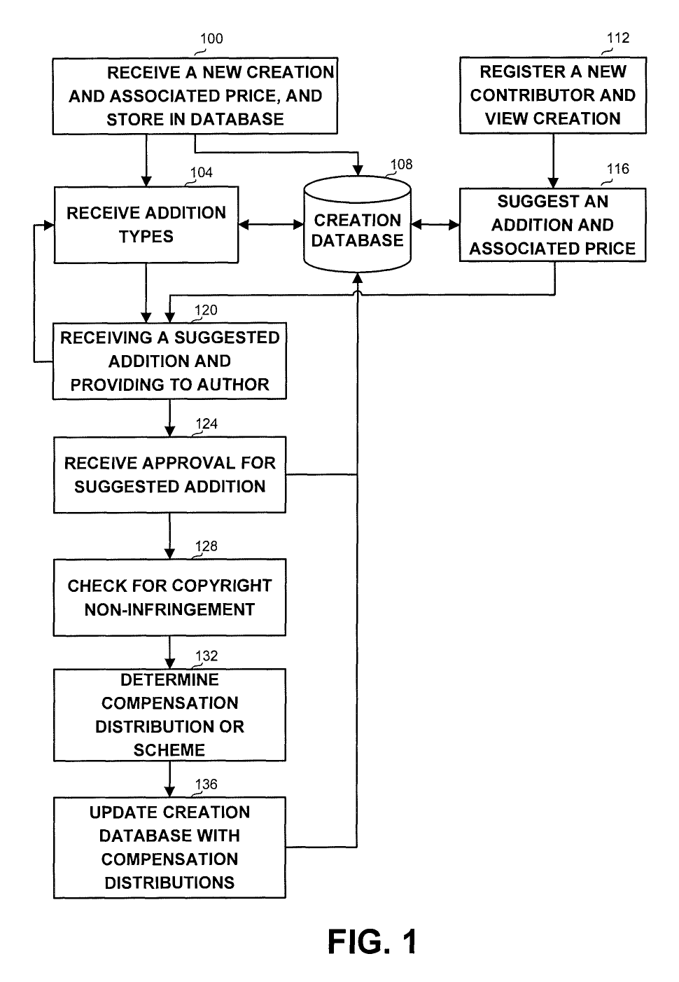

Referring now to FIG. 1, showing a flowchart of steps in a method for creating an enhanced or a multi-version creation.

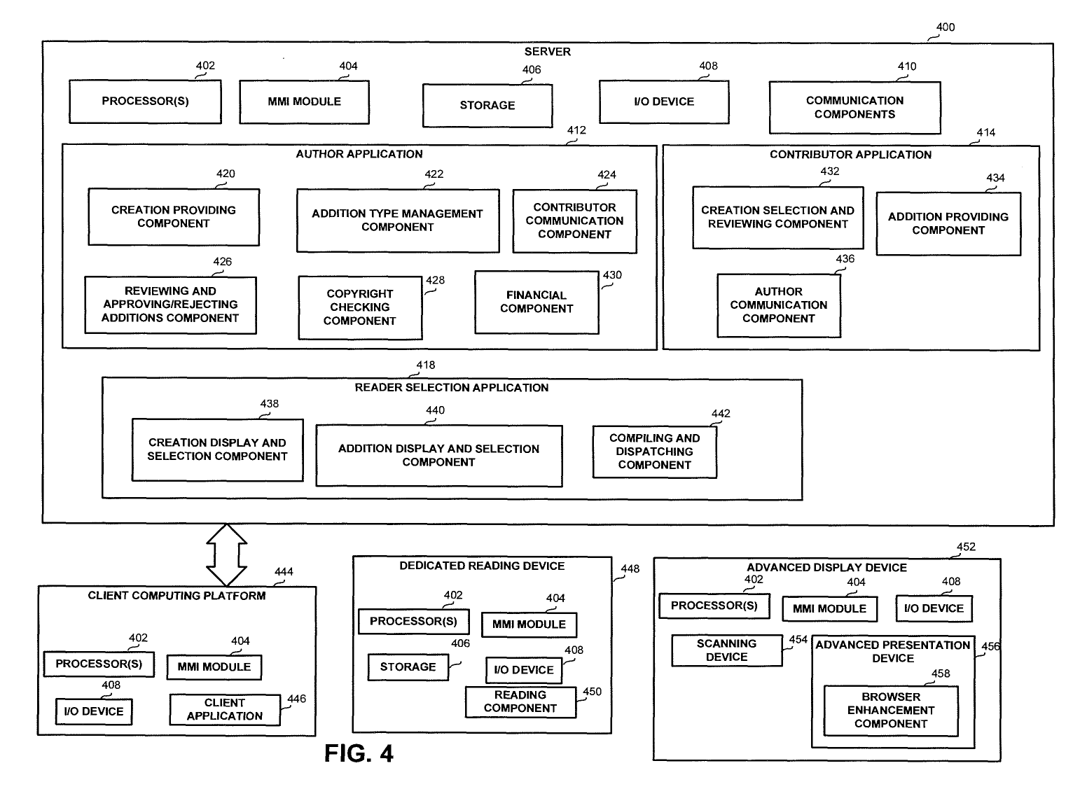

On step 100 a new creation is received by a system such as the system described in association with FIG. 4 below. The creation may be any textual creation, such as a book, a play, or the like, or any artistic creation with visual display such as drawings, notes for a musical piece, or the like. The creation may be associated with a price or a price range.

The creation as well as the price may be stored on a physical storage device, for example a storage device storing creation database 108.

On optional step 104, types of additions to the creation may be received. For example, if the original creation registered on step 100 is a book, the addition types indicated by the author may include illustrations, photographs, summaries, translations, notes, or the like; if the original creation registered on step 100 is a drawing, the addition types may include accompanying text such as poetry; if the original creation registered on step 100 comprises notes for a musical piece, the addition types may include notes for other instruments, or the like. In general, the addition may be but is not limited to any of the following: part of the creation; a translation; a summary; comments; personal comments; an illustration; a drawing; a photograph; a design; an animation; a link; an audio file or stream; a video file or stream; broadcasting; an article; a map; a location coordinates; a critique; an alternative phrasing; musical notes; a recipe; a calculator; an address list; an electronic address list; or a phone directory.

The addition types may also be stored within creation database 108.

On step 112, a potential contributor may be registered with the system, and may be presented with the creation as registered by the author.

Viewing may be limited to registered contributors so as not to publicly expose the creation prematurely. However, in other embodiments, every user may be able to view the creation. In yet further embodiments, every user may be able to get a listing of all creations, while only registered or otherwise recognized contributors may be able to view the full creation. In yet further embodiments, viewing the full creation may depend upon a payment.

Based upon the creation and optionally the price as provided by the author on step 100, on step 116 the contributor may suggest one or more additions and optionally a price or price range associated with each addition. The suggested additions and prices may be stored in creation database 108, and may be sent directly or via the system to the author.

On step 120, the addition suggested by the contributor on step 116 and the associated price may be provided to the author. It will be appreciated that one or more communication rounds may take place between the author and the contributor, related to the provided content of the addition, to the price, to how the addition should be integrated into the creation, or the like.

On step 124, an approval is received from the author, which approves the suggested addition to be suggested with the creation. The approval may also be stored with creation database 108.

On optional step 128, the addition may be checked for copyright infringement. The addition, whether it comprises text segments, photographs, designs, etc., is compared against the original creation and optionally against other materials available to the system, to determine the originality and authenticity of contributions according to criteria in accordance with the applicable copyright law, optionally in addition to a legal originality declaration by the contributor. The percentage of the addition which is new is determined, as well as the percentage of the addition that is substantially based on or copied from the creation. Abstracts or summaries may be compared to the original creation and the extent of original words, optionally in accordance with their original order, may be determined, as a percent of the abstract. Other creation types may require other considerations. For example if animation is created based upon illustrations of another artist, the drawings can be compared and it may be determined whether the original illustrator is entitled to royalties. In another example, if a writer wrote lyrics, a composer wrote the music and a performer recorded the song, the system will determine the writer and composer and will determine if royalties are to be paid. It will be appreciated that when comparing texts, the percent of the derived text which is taken from the original creation, and optionally the royalties may be determined mathematically. In other creation types, it may be determined who is/are the source of a creations, and ask for their permission or negotiate royalties with them.

If the addition is found to infringe copyrights, or if the percentage of original work within the addition is below a predetermined value, the addition may be rejected.

On step 132, the compensation division between the author and the contributor may be determined, based upon a multiplicity of parameters, such as but not limited to: the prices indicated by the author and the contributors; a rank set by the author for the type of additions, for example an author of a scientific paper in a rare language may indicate additions of type “translations” to be of high value to the paper, while photographs may be indicated as less desired; the difference in scope between the creation and the additions; the originality percentage of the addition as determined on step 128, or the like. It will be appreciated that the division may change over time as more additions become available, as certain types of additions are proven more popular than others; or the like.

In some embodiments, the final distribution may not be determined, since it may depend on factors such as rules, the user's selection, a maximal price, fixed fee charged for additions, decreased extra fees as the number of purchased contributions increases, or the like. For example, if a user wishes to purchase two summaries of different lengths or two translations, he may be charged for the summaries or translations less than the sum that may have been charged for the summaries or translations when purchased separately. In such cases, a compensation distribution scheme or formula may be determined into which the actual factors would be set, rather than a fixed payment distribution.

On step 136, creation database 108 may be updated with the compensation division.

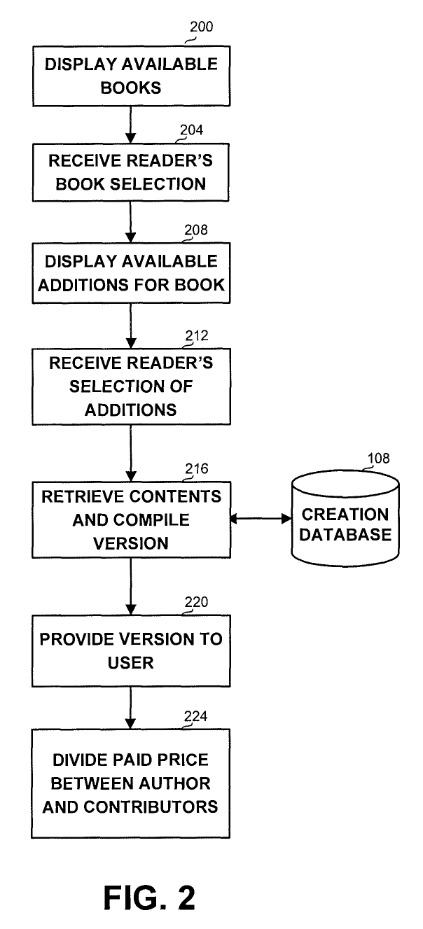

Referring now to FIG. 2, showing a flowchart of steps in a method for receiving an enhanced version of a creation.

On step 200, a list of available books or other creations is displayed to a user, generally referred to as a reader. The list can be displayed alphabetically, by category, by author's name, as a query result, as a collection of images, or the like.

On step 204, a user's selection of one or more books is received.

On step 208, the user is displayed with a list or another collection of additions available for one of the selected creations. In some embodiments the full additions can be displayed. The collection of additions can be displayed by categories, such as “translations”, “summaries”, “commentaries”, or the like. Alternatively, the collection of additions can be displayed in a graphic manner such as a matrix, a circle, or the like.

On step 212, the reader's selection of one or more additions is received. The selection can comprise zero, one or more additions of each addition category. For example, a reader can order the book with two sets of illustrations, a summary and no translation.

Steps 200, 204, 208 and 212 can be performed after the reader has registered to the system. Alternatively, the steps can also be performed also for a reader that has not registered to the system yet.

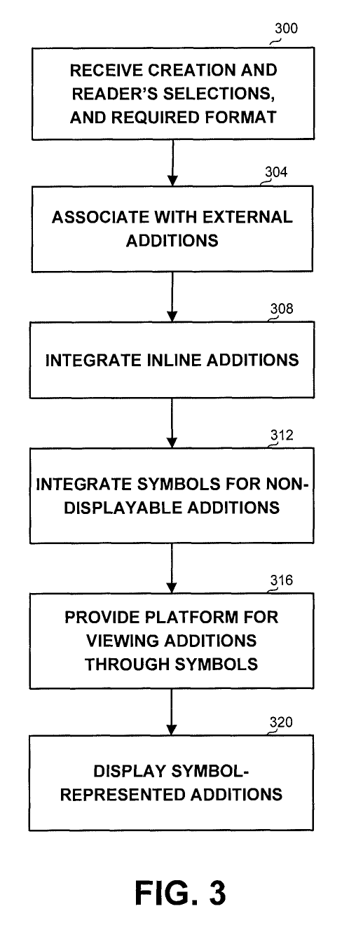

On step 216, the book and the additions are retrieved from creation database 108, and a version comprising the contents of the book and all the selected additions is compiled. The compilation process is further detailed in association with FIG. 3 below. In some embodiments, step 216 can only be performed after the reader has registered with the system and optionally after the user has paid for the creation.

On step 220, the version of the book comprising the additions as selected by the user and compiled on step 216 is delivered to the reader. If the reader chooses to receive a physical book it may be provided as a physical book sent over by mail, as a printable file which the reader may print, or the like. If the reader chooses to receive a file readable by an electronic book reader, the file may be provided to the reader for download, sent in an e-mail, or the like. The reader can then view the book and the additions on the digital book reader, or on any other computing platform that supports the book format. Some additions, such as video clips that may not be supported by an electronic book reader may be represented by symbols, wherein another computing platform may scan the symbol and display the addition.

On step 224, the price paid by the reader is divided between all contributors, in accordance with the compensation distribution as determined on step 132, or in accordance with a scheme or formula determined on step 132.

Referring now to FIG. 3, showing a flowchart of steps in a method for compiling a particular version of an enhanced version of a creation.

On step 300 the creation selected by the reader as received on step 204, and the selected additions as received on step 212 are received. The creation and/or the selections may be received in full, or simply identifiers or pointers thereof may be received. The format at which the book is to be prepared may also be received, for example a printed edition, a PDF (Portable Document Format), a document with links, or the like.

On step 304, the creation is associated with external additions such as summaries, translations, or the like. External additions generally refer to additions that are not associated with a particular location within the text.

On step 308, parts of inline additions are integrated into the book. Inline additions generally refer to additions which are associated with a predetermined location or location range within the text, such as illustrations that may be associated with a particular paragraph, page, chapter, or the like; personal notes associated with a word, a sentence, a paragraph, or others.

It will be appreciated that some additions may be considered as either external or inline. For example in some embodiments a translation may be provided as an independent document, while in other embodiments each word, sentence, paragraph, chapter or the like may be associated with corresponding translation.

It will also be appreciated that some additions may replace original content, such as alternative endings or other parts of a book, or the like. In such cases, the alternative part can be provided in addition to or instead of the original content.

On step 312, symbols are integrated into the book instead of non-displayable materials. For example, if the book is to be generated as a printed book or an e-reader displayable book, additions such as audio or video clips may be represented by barcodes or other graphic symbols. An example of such a symbol is the QR (Quick Response) Code, a specific matrix barcode (or two-dimensional code) that is readable by many camera smart phones nowadays. The code includes black modules arranged in a square pattern on a white background. The information encoded may be text, URL, or other data. The QR code is designed to allow its contents to be decoded at high speed.

When the user wishes to view these additions, the user can scan the symbols using for example a device such as a smart phone, which will access a web page encoded by the symbol, and present the material as stored on the web page.

On step 316, a platform for viewing the additions which cannot be displayed by the printed book or by the e-reader is provided, the platform optionally comprising a scanner for scanning the symbol, and an application for associating the symbol with an addition or a pointer to an addition, and displaying the addition, for example by accessing a web page. On step 320, the platform may scan the symbols and display the materials.

It will be appreciated that excluding step 300 which is to be performed before steps 304, 308, 312, 316 and 320, and step 320 which is to be performed after step 300, 304, 308, 312 and 316, the other steps can be performed at any desired order.

Referring now to FIG. 4 showing a system for creating, distributing and viewing an enhanced version of a creation.

The system generally comprises a server 400, which comprises and executes an author application 412, a contributor application 414 and a reader application 416.

Each user may be using one or more client computing platforms 444 such as an author client computing platform, a contributor client computing platform, or a reader client computing platform, wherein each such client may communicate with server 400. The reader client may be integrated into a reading device used by a reader for reading the book after selecting additions. However, the reader device can also be independent of the reader client, such that a reader or another person makes the selections on one platform, and reads the book on another platform.

It will be appreciated that the computational load may be distributed in any desired manner between the server applications and the various clients, depending on considerations such as efficiency, bandwidth availability, security, or the like.

Server 400 comprises one or more processors 402, any of which may be any Central Processing Unit (CPU), a microprocessor, an electronic circuit, an Integrated Circuit (IC) or the like. Alternatively, processor 402 can be implemented as hardware or configurable hardware such as field programmable gate array (FPGA) or application specific integrated circuit (ASIC). In yet other alternatives, processor 402 can be implemented as firmware written for or ported to a specific processor such as digital signal processor (DSP) or microcontrollers. Processor 402 may be used for performing mathematical, logical or any other instructions required by computing server 400 or any of it subcomponents.

In some embodiments, server 400 may comprise an MMI (man-machine interface) module 404. MMI module 404 may be utilized for receiving input or providing output to and from server 400 or a user.

In some exemplary embodiments, server 400 may comprise or be associated with one or more storage devices such as storage device 406. Storage device 406 may be non-transitory (non-volatile) or transitory (volatile). For example, storage device 406 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. Storage device 406 may contain creation database 108 detailed in associations with FIG. 1, or otherwise access creation database 108. In other embodiments, creation database 108 can be stored on another storage device in communication with storage device 406. In some embodiments, storage device 406 may retain program code operative to cause processor 402 to perform acts associated with any of the steps of FIG. 1, 2 or 3 detailed above. Storage device 406 may also retain additional information such as users' data, financial data, or other information.

Server 400 may further comprise or be associated with one or more Input/Output (I/O) devices 408 such as a terminal, a display, a keyboard, a touch screen, an input device or the like, to interact with the system, to provide selections, or the like.

Server 400 may also comprise or be associated with one or more communication components 410 for communicating with external entities, such as the Internet for communicating with client machines, external databases, or the like.

Server 400 may comprise and execute applications to be used by all users of the system, including authors, contributors and readers. Thus, server 400 may comprise author application 412, contributor application 414 and reader selection application 418.

It will be appreciated that author application 412, contributor application 414 and reader selection application 418 can be implemented as separate applications, executables, static libraries, dynamic link libraries, or as a single application with different access levels, or any combination thereof.

In some exemplary embodiments, author application 412 may comprise creation providing component 420 in which an author provides a creation to the system, for contributors to offer additions and for readers to select. In some embodiments, the author can provide a non-complete version of the creation so as to cooperate with contributors such as illustrators during the work.

Author application 412 may further comprise addition type management component 422 for defining addition types acceptable for the creation, such as translations, commentaries, summaries, illustration or the like, or for approving or rejecting addition types suggested by contributors, if a contributor wants to add an addition of a type that has not been defined by the author.

Author application 412 may also comprise contributor communication component 424 for the author to communicate with one or more contributors, including for example receiving and answering questions, providing comments to materials provided by a contributor, negotiating terms, or the like. It will be appreciated that the communication between the author and the contributors can be direct or indirect, e.g., through a third person or computerized entity.

A further component of author application 412 may be reviewing and approving/rejecting additions component 426 for reviewing the materials provided by contributors and approving them for being part of the offering associated with the creation, or rejecting them. It will be appreciated that parts or all of component 426 can be implemented as part of contributor communication component 424.

Author application 412 may further comprise a copyright checking component 428 for checking the originality of additions. The additions may be checked against the author's creation to determine the percentage of overlap, or other parameters. For example, when an addition is a summary, it is acceptable that most of the words in the summary are extracted from the creation. However, the originality of the summary as a whole may be determined upon the difference from the author's creation.

Author application 412 may further comprise a financial component 430 for performing the finance-related operations, including for example determining the payment distribution between an author and contributors, whether in actual currency or as a scheme or formula. If only a scheme is determined, then once a reader has purchased a version of the creation the actual payment is distributed between the author and contributors, keeping financial information related to users, communicating with credit companies, or the like. Financial component 430 may also calculate a discount or credit a user that agrees to receive commercial information as part of the creation, or may manage financial transactions between the author and any of the contributors and an advertising entity.

Contributor application 414 may comprise a creation selection and reviewing component 432 for viewing creations available for contributors, selecting one or more creations and reviewing them. The creations may be complete and final, or incomplete and still being worked on.

Contributor application 414 may further comprise addition providing component for providing an addition to a creation, which may then be evaluated by the author.

Yet another component of contributor application 414 is author communication component 436 which provides for the contributor to communicate with the author who is using contributor communication component 424.

It will be appreciated that some embodiments can support secondary contributors, which communicate and whose additions are approved/rejected by contributors. In such embodiments, contributor application 414 may comprise further subcomponents of author application 412.

Reader selection application 418 provides interface for a reader to select a book or another creation with one or more additions.

Reader selection application 418 comprises a creation display and selection component 438 for displaying a list of available books or other creations to a reader, and receiving a selection from the reader.

Reader selection application 418 may further comprise addition display and selection component 440 for displaying the additions available to the creation, and selecting one or more additions of one or more types, such as translations, commentaries, illustrations, designs, or the like. The additions available to the user may depend on the media type or platform on which the user intends to view the creation.

In some embodiments, commercial information or advertisements can also be suggested as additions available to the reader, wherein the commercial information or advertisements may take any form, such as photographs, illustrations, text, audio, video or the like. In some embodiments, a user selecting or agreeing to receive such commercial information may enjoy a discount in the price he pays for the book or coupons which may be associated with the book or advertisements. If the user enjoys a price reduction, the author or any of the contributors may receive a lesser sum from the reader, but they may also be compensated by the advertiser. In some embodiments the user may receive credits for future interactions with the system in return to agreeing to receive the commercial information. Such commercial information may be particularly useful for instruction books, such as cook books, your guides, or the like. Reader selection application 418 may further comprise compiling and dispatching component 442 for compiling the creation with the additions as selected by the reader, and dispatching the creation to the reader using physical mail for printed book, an electronic format with all viewable materials if the user intends to read the book on a computing platform with all required functionality, a book with symbols to be used on an electric book reader, or the like. If the reader chose or agreed to receive commercial information, this information is embedded into the creation as well.

In some embodiments, the users, including one or more authors, one or more contributors, or one or more readers may communicate with the respective server applications using client applications executed on client computing platforms.

Each client computing platform 444 may comprise one or more processors 402, one or more MMI modules 404 or one or more I/O devices 408, as described in association with server 400 above.

Each client computing platform may comprise a client application 446 such as an author client application, a contributor client application or a reader client application which communicates with the corresponding applications executed by server 400 to provide the required services to the author, contributor or reader.

It will be appreciated that each client computing platform can comprise more than one client application and thus serve two or more users of different types.

It will also be appreciated that in some embodiments the services of client application 446 can be provided by a web application that does not need to be installed on client computing platform 444.

Server 400 and client computing platform 444 can communicate using any communication channel and protocol, such as the Internet, Intranet, cellular network, Local Area Network (LAN), Wide Area Network (WAN), or the like.

Dedicated Reading device 448 is a computing platform used by a reader to read or view the book or another creation with additions as selected by the reader.

Dedicated Reading device 448 may comprise one or more processors 402, one or more MMI modules 404, or one or more I/O devices 408, as described in association with server 400 above. The creation to be read may be introduced to dedicated reading device 448 through a communication port, a removable storage device, or the like, and may present the creation on a display device such as a screen.

Dedicated Reading device 448 may also comprise reading component 450 which may be an application, which receives one or more files or streams representing the creation and additions, and displays them to the reader.

In some embodiments, the reading device executing reading component 450 may display text files, PDF files, illustrations, or the like. In some embodiments, dedicated reading device 448 may not be able to display all additions such as audio or video files, browse internet locations, or the like.

In such cases, a symbol such as a barcode symbol may be displayed instead of the required content, such that an advanced display device 452 can be utilized for displaying the content. Advanced display device 452 may be any desktop computer, laptop computer, tablet, Smartphone, or the like.

Advanced display device 452 may comprise one or more processors 402, one or more MMI modules 404, or one or more I/O devices 408, as described in association with server 400 above. Advanced display device 452 may also comprise a scanning device 454 for scanning a symbol from dedicated reading device 448 or from a printed book, and an advanced presentation device 456 for accessing or displaying the materials referred to by the symbol. For example by accessing a web page, and presenting the content.

Advanced presentation device 456 may also be used for reading or viewing the whole book, using for example a web browser. Advanced presentation device 456 may further comprise a browser enhancement component 458 for selecting the best browser to view a specific book, and to supply advanced reading features such as page turning, book marking, side notes editing, browsing to web pages through links, or the like.

The disclosed components may be implemented using any programming and/or markup language such as C, C#, C++, Java, HTML or others, and developed under any development environment, such as .NET, J2EE, or others.

It will be appreciated that the computing platforms and components disclosed above represent exemplary embodiments, and that other combinations or divisions of computing platforms or applications can be used.

The disclosed methods and system provide for creating and receiving multi-version or enhanced creations such as books, in which one or more contributors provide additions, and a reader can choose additions I accordance with his preferences.

This provides for involvement by a large number of participants, optionally from different places around the world, in creating and enhancing a book. This enables a large number of versions, by encouraging creation of additional content.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step or component to the teachings without departing from the essential scope thereof. Therefore, it is intended that the disclosed subject matter not be limited to the particular embodiment disclosed as the best mode contemplated for carrying out this invention, but only by the claims that follow.

In the description and claims of the application, each of the words “comprise” “include” and “have”, and forms thereof, are not necessarily limited to members in a list with which the words may be associated.

1. A method for providing an enriched version of a creation, the method comprising:
using one or more processors of a server computing platform:
receiving a creation from an author who uses an author client computing platform, and storing said creation in a creation database of said server computing platform;
receiving from a contributor who uses a contributor client computing platform, through a network, at least one suggested addition to said creation, wherein said at least one suggested addition is based on said creation;
receiving from a sub-contributor who uses a contributor client computing platform, through a network, at least one suggested sub-addition to said at least one suggested addition, wherein said at least one suggested sub-addition is based on said at least one suggested addition,
wherein each of said at least one suggested addition and said at least one suggested sub-addition is of a type selected from the group consisting of: a translation, a summary, an illustration, a drawing, a photograph, an animation, a link, an audio file or stream, a video file or stream, and a critique;
providing said at least one suggested addition and said at least one suggested sub-addition to said author, and receiving approval for said at least one suggested addition and said at least one suggested sub-addition from said author;
displaying to a reader, who uses a digital reading platform, indications to said creation, to said at least one suggested addition and to said at least one suggested sub-addition, and receiving from said reader a selection of said creation and one or more of: said at least one suggested addition and said at least one suggested sub-addition;
compiling an enriched version of said creation and providing said enriched version to said digital reading platform of said reader, wherein said enriched version comprises said creation and selected one or more of: said at least one suggested addition and said at least one suggested sub-addition; and
receiving payment from said reader for said enriched version, and distributing said payment, based on said selection, between said author of said creation and one or more of: said contributor of said at least one suggested addition, and said sub-contributor of said at least one suggested sub-addition,
wherein if said selection includes said at least one suggested sub-addition, then, in the distribution: (a) said author is compensated for all of said creation, said at least one suggested addition and said at least one suggested sub-addition, (b) said contributor is compensated for said at least one suggested addition and said at least one suggested sub-addition, and (c) said sub-contributor is compensated for said at least one suggested sub-addition,
and wherein if said selection includes said at least one suggested addition, then, in the distribution: (a) said author is compensated for said creation and said at least one suggested addition, and (b) said contributor is compensated for said at least one suggested addition.

2. (canceled)

3. (canceled)

4. The method of claim 1, wherein one or more of said at least one suggested addition and said at least one suggested sub-addition comprise commercial information, and wherein the reader is entitled to a discount or is credited for at least part of the payment.

5. The method of claim 1, wherein the digital reading platform is a digital book reader.

6. (canceled)

7. The method of claim 1, wherein compiling the enriched version of the creation comprises at least one action selected from the group consisting of: associating the creation with an external addition; and integrating parts of inline additions into the creation.

8. The method of claim 1, wherein compiling the enriched version of the creation comprises integrating symbols representing additions non-displayable by the digital reading platform into the creation.

9. The method of claim 8, wherein the symbols are adapted to be scanned by an advanced display device, the advanced display device capable of displaying the additions non-displayable by the reading digital platform.

10. The method of claim 1, further comprising receiving at least one type of additions to be suggested.

11. The method of claim 1, wherein the at least one suggested addition is internally represented as a matrix, wherein each dimension of the matrix relates to a type of addition, and wherein each dimension of the matrix comprises a number of entries equal to one plus a number of additions available of the type of addition.

12. The method of claim 1, further comprising checking for the originality of one or more of the at least one suggested addition and said at least one suggested sub-addition.

13-24. (canceled)

25. A non-transitory computer readable storage medium having computer-readable code stored thereon, that, when executed by at least one processor, cause said at least one processor to:
receive a creation from an author who uses an author client computing platform, and store said creation in a creation database of said server computing platform;
receive from at least one contributor who uses a contributor client computing platform, through a network, at least one suggested addition to said creation, wherein said at least one suggested addition is based on said creation;
receiving from a sub-contributor who uses a contributor client computing platform, through a network, at least one suggested sub-addition to said at least one suggested addition, wherein said at least one suggested sub-addition is based on said at least one suggested addition,
wherein each of said at least one suggested addition and said at least one suggested sub-addition is of a type selected from the group consisting of: a translation, a summary, a comment, an illustration, a drawing, a photograph, an animation, a link, an audio file or stream, a video file or stream, and a critique;
provide said at least one suggested addition and said at least one suggested sub-addition to the author, and receive approval for said at least one suggested addition and said at least one suggested sub-addition from said author;
display to a reader, who uses a digital reading platform, indications to said creation, to said at least one suggested addition and to said at least one suggested sub-addition, and receive from said reader a selection of said creation and one or more of: said at least one selected addition and said at least one suggested sub-addition;
compile an enriched version of said creation and provide said enriched version to said digital reading platform of said reader, wherein said enriched version comprises said creation and selected one or more of: said at least one suggested addition and said at least one suggested sub-addition; and
receive payment from said reader for said enriched version, and distribute said payment, based on said selection, between said author of said creation and one or more of: said contributor of said at least one suggested addition, and said sub-contributor of said at least one suggested sub-addition,
wherein if said selection includes said at least one suggested sub-addition, then, in the distribution: (a) said author is compensated for all of said creation, said at least one suggested addition and said at least one suggested sub-addition, (b) said contributor is compensated for said at least one suggested addition and said at least one suggested sub-addition, and (c) said sub-contributor is compensated for said at least one suggested sub-addition,
and wherein if said selection includes said at least one suggested addition, then, in the distribution: (a) said author is compensated for said creation and said at least one suggested addition, and (b) said contributor is compensated for said at least one suggested addition.

26. The non-transitory computer readable storage medium of claim 25, wherein one or more of said at least one suggested addition and said at least one suggested sub-addition comprise commercial information, and wherein said reader is entitled to a discount or is credited for at least part of the payment.

27. The non-transitory computer readable storage medium of claim 25, wherein said digital reading platform is a digital book reader.

28. The non-transitory computer readable storage medium of claim 25, wherein compile said enriched version comprises at least one action selected from the group consisting of: associating said creation with an external addition; and integrating parts of inline additions into said creation.

29. The non-transitory computer readable storage medium of claim 25, wherein compile said enriched version comprises integrating symbols representing additions non-displayable by said digital reading platform into said creation.

30. The non-transitory computer readable storage medium of claim 29, wherein said symbols are adapted to be scanned by an advanced display device, the advanced display device capable of displaying said additions non-displayable by the reading digital platform.

31. The non-transitory computer readable storage medium of claim 25, wherein said computer-readable code, when executed by said at least one processor, further causes said at least one processor to receive at least one type of additions to be suggested.

32. The non-transitory computer readable storage medium of claim 25, wherein said at least one suggested addition is internally represented as a matrix, wherein each dimension of the matrix relates to a type of addition, and wherein each dimension of the matrix comprises a number of entries equal to one plus a number of additions available of the type of addition.

33. The non-transitory computer readable storage medium of claim 25, wherein said computer-readable code, when executed by said at least one processor, further causes said at least one processor to check for the originality of one or more of the at least one suggested addition and said at least one suggested sub-addition.
